(19) United States
(12) Patent Application Publication
(10) Pub. No.: US 2005/0134032 A1
(43) Pub. Date: Jun. 23, 2005

(54) Airbag folding method

(76) Inventors: Drew G. Downing, Almont, MI (US); Spencer W. Chavez, Linden, MI (US)

Correspondence Address: Dinnin & Dunn, P.C., Suite 500, 2701 Cambridge Ct., Auburn Hills, MI, 48326, US

(21) Appl. No.: 10/738,834

(22) Filed: Dec. 17, 2003

(51) Int. Cl. B60R 21/16

(52) U.S. Cl. 280/743.1

(57) ABSTRACT

The present invention provides an airbag folding method comprising a plurality of steps. The method begins by forming four inward tucks along each of a first and second edge of an airbag, the tucks having substantially similar depths and extending substantially in parallel. Next, a first half of the airbag is folded a plurality of times, thereby forming a first fold body, and a second half of the airbag is folded a plurality of times, thereby forming a second fold body. The inward tucks form a plurality of adjacent layers extending along first and second edges of the airbag that upon supplying an inflation gas to an interior of the airbag resist unfolding, thereby directing the inflation gas initially predominantly into the first and second fold bodies.

### TECHNICAL FIELD

The present invention relates generally to inflatable restraint devices for motor vehicles, and more particularly to a method of folding such a device.

### BACKGROUND OF THE INVENTION

In recent years, engineering efforts in automobile safety systems have increasingly focused on inflatable restraint devices and methods/systems for their deployment. Of particular interest to designers are methods of folding the inflatable device or airbag to optimize the manner in which it deploys. Designs differ among the different types of airbags, for example, driver side, passenger side and side-impact airbags offer varying optimal deployment characteristics. Moreover, different vehicle structures as well as size and type of inflatable restraint apparatuses all provide different, sometimes competing considerations when developing airbag fold designs. For example, children or other relatively small occupants may have different requirements than larger occupants when it comes to optimizing vehicle safety systems. Complicating matters further, occupants may be out of a normal riding position during airbag deployment. There are thus continuing challenges to engineering broadly applicable systems that will operate effectively in view of the broad range of vehicle and occupant characteristics.

Further concerns relate to the equipment used in the inflatable restraint system other than the airbag itself. For instance, the inflator tends to be the heaviest, most expensive part of the system. Development of increasingly complex airbag structural and folding designs have been accompanied by the need for more powerful, and thus heavier and more complex inflators. Efficiency and production economics continue to drive engineering, however, and designers are therefore continually searching for ways to lighten and simplify restraint systems.

### SUMMARY OF THE INVENTION

The present invention provides an airbag folding method comprising a plurality of steps. The method preferably begins by forming a set of pleats along each of a first and second edge of an airbag, the pleats having substantially equal depths. Next, a first half of the airbag is preferably folded a plurality of times, thereby forming a first fold body, and a second half of the airbag is preferably folded a plurality of times, thereby forming a second fold body. The pleats preferably form a plurality of adjacent layers extending along first and second edges of the airbag that upon supplying an inflation gas to an interior of the airbag resist unfolding, thereby directing the inflation gas initially predominantly into the first and second fold bodies.

### BRIEF DESCRIPTION OF THE DRAWINGS

FIG. 1 is a top perspective view of an unfolded airbag suitable for folding by a method according to a preferred embodiment of the present invention;

FIG. 2 is a top view of the airbag of claim 1 partially folded according to the present invention;

FIG. 3 is an end view of an airbag similar to FIG. 2;

FIG. 4 is a top view of an airbag similar to FIG. 2;

FIG. 5 is a sectioned view taken through line A-A of FIG. 4;

FIG. 6 is a side view of an airbag similar to FIG. 4;

FIGS. 7-11 are side views of an airbag sequentially folded according to a preferred embodiment of the present invention.

### DETAILED DESCRIPTION

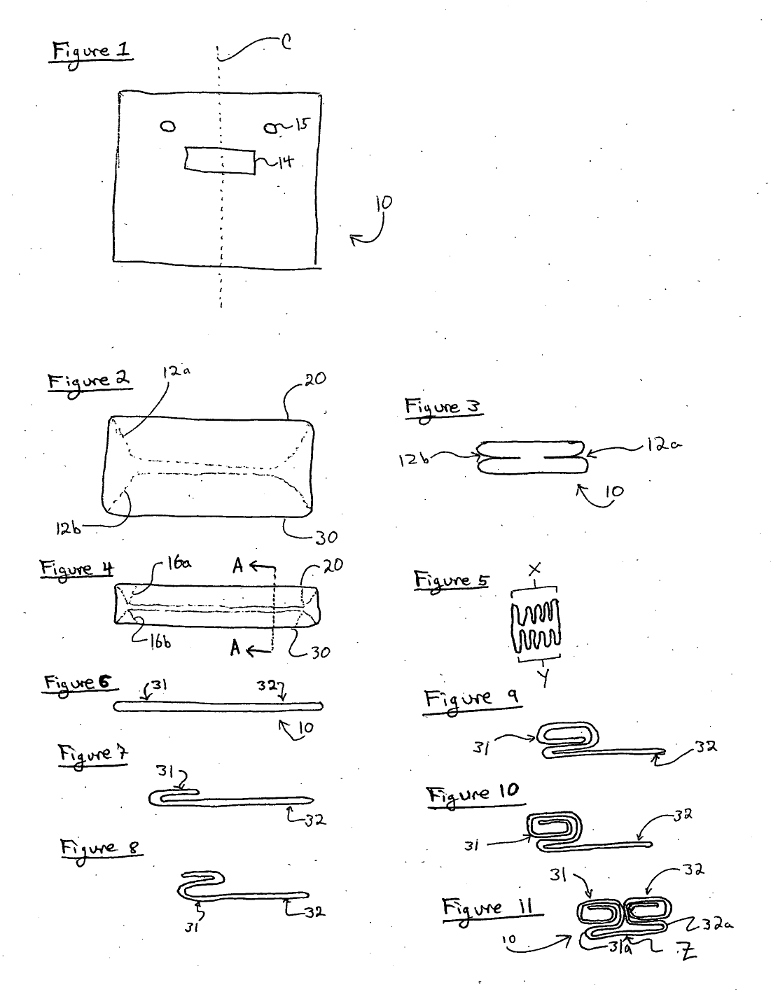

Referring to FIG. 1, there is shown a top perspective view of an unfolded airbag 10 suitable for folding according to the present invention. The presently disclosed airbag folding method may be utilized with airbags positioned at various points in the automobile, for instance, top-mounts, mid-mounts, and lower-mounts, as well as in side-impact and driver-side systems. Those skilled in the art will appreciate that although rectangular airbags are preferred, round, elongate and other airbags may be folded according to the present invention. In a preferred embodiment, airbag 10 is attached by any known means to an inflator housing (not shown) near a throat 14. The inflator housing is preferably secured adjacent the throat 14 by inserting a plurality of pegs (not shown) through matching holes 15 in the airbag. It should be appreciated that the various figures referred to herein are merely illustrative of the airbag folding method, as well as the airbag and inflatable restraint system components preferred in the practice of the present invention. Therefore, the various dimensions, proportions and materials illustrated should not be taken to limit the manner in which the invention may be practiced.

The method preferably begins by initially laying the subject airbag 10 substantially flat on a work surface such as a table. Although it is generally contemplated that the airbag will be folded manually, an automated system might be used without departing from the scope of the present invention. The various folding steps disclosed herein may be facilitated by substantially flattening each fold on the work surface (and therefore the entire airbag), however, the process can be carried out without flattening the airbag if desired. Referring to FIG. 2, a first set of inwardly extending tucks 12a and 12b are formed at a first or top edge 20 and a second or bottom edge 30 of airbag 10. FIG. 3 is an end view of airbag 10 similar to its conformation in FIG. 2, illustrating inward tucks 12a and 12b. Referring to FIG. 4, a second set of tucks 16a and 16b are formed along top edge 20 and bottom edge 30. In a preferred embodiment, a total of four tucks are made along each of top and bottom edges 20 and 30. FIG. 5 is a cross section of FIG. 4 taken along line A-A. As illustrated in FIG. 5, all of the tucking steps of the present method preferably form tuck sets or pleats “X” and “Y” comprising a plurality of substantially equal depth tucked regions extending substantially perpendicular to centerline “C”, illustrated in FIG. 1.

Upon folding airbag 10 as illustrated in FIG. 5, several subsequent steps are taken to prepare airbag 10 for installation into an airbag housing (not shown), and thenceforth in a vehicle. Referring to FIG. 6, there is shown an end view of airbag 10, substantially as it would appear when folded into the conformation illustrated in FIG. 5 and viewed from top or bottom edge 20 or 30. Airbag 10 includes first and second halves 31 and 32. FIGS. 7-11 illustrate steps whereby the respective halves 31 and 32 are each folded or rolled into relatively compact first and second fold bodies (also denoted 31 and 32). In a preferred embodiment, fold bodies 31 and 32 are formed such that a lower fold 31a and 32a in each fold body hooks outwardly and is doubled back upon itself relative to a center Z of airbag 10. Stated another way, the lowermost folds in each fold body “open” toward each other, toward center Z. Once folded into the conformation illustrated in FIG. 11, airbag 10 may be positioned in an airbag housing, and installed in a vehicle. Airbag 10 may optionally be covered with a protective wrapping prior to positioning in the housing to assist in maintaining the integrity of the folded airbag during storage.

Airbag 10 is preferably activated during or just prior to a crash or sudden vehicle deceleration. In a preferred embodiment, the associated vehicle is equipped with a crash sensor (not shown), which sends an electrical activation signal to a gas generator/inflator (also not shown) for supplying inflation gas to airbag 10. The signal preferably induces the rapid production/release of inflation gas in a manner well known in the art, which is supplied to an interior of airbag 10 via throat 14. The gas is preferably directed into airbag 10, causing relatively rapid inflation thereof. Airbag 10 bursts through or displaces the various airbag covers, trim panels, etc. used in housing the airbag system, in a manner also well known in the art. By forming a set of pleats X and Y along top and bottom edges 20 and 30, the regions of airbag 10 proximate the pleats tend to be more resistant to inflation than untucked regions of airbag 10.

Upon activation of airbag 10, gas is supplied to the airbag interior. The inflation gas is supplied via throat 14, and has a tendency to initially flow predominantly toward first and second halves 31 and 32. This is due to the fact that a relatively unobstructed pathway for the gas to flow exists in the directions of first and second halves 31 and 32 relative to throat 14, i.e. in a direction substantially perpendicular to centerline “C” . Gas flowing in a direction substantially along centerline C must force unfolding or untucking of the pleats along top and bottom edges 20 and 30. Thus, the present folding method induces gas to flow initially predominantly toward the folded first and second ends 31 and 32. As a result, folded first and second ends 31 and 32 initially inflate substantially as two separate side-by-side expanding lobes of airbag 10. As first and second ends 31 and 32 begin to fill with inflation gas, untucking of pleated regions X and Y begins. Essentially simultaneously, gas pressure induces expansion of airbag 10 proximate center Z. The expanding airbag pushes against first and second fold bodies 31 and 32, urging them outwardly. Utilizing lower folds 31a and 32a that hook outwardly relative to center Z increases the tendency for airbag 10 to inflate substantially outwardly relative to center Z.

Thus, during initial inflation, frictional interaction among the layers of pleated regions X and Y are resistive to inflation, giving the inflation gas the tendency to flow initially predominantly into fold bodies 31 and 32. By folding fold bodies 31 and 32 in the prescribed manner, the initial inflation of center Z enhances the tendency for outward expansion of airbag 10. Upon still further inflation, the inflation of airbag 10 proximate center Z will catch up with inflation of first and second halves 31 and 32. Eventually, the tucks are all untucked and airbag 10 will reach a fully inflated state. In a preferred embodiment, airbag 10 is mounted in a vehicle dashboard such that folded first and second ends 31 and 32 are positioned substantially left and right, respectively, of the center of the vehicle passenger seat. Thus, activation of airbag 10 preferably provides left and right expanding lobes positioned at left and right positions relative to a vehicle occupant. Accordingly, a center region of the airbag is “softer” than the respective left and right lobes. An occupant that impacts either of the left or right expanding lobes has a tendency to be guided toward the less expanded center region of the airbag. During certain crashes or other sudden vehicle deceleration wherein the occupant is out of a normal riding position, the expanding lobes can “scoop” an occupant toward the center region, reducing the risk of injury in some instances. Further, because the center region of the airbag inflates more slowly than the lateral, first and second regions 31 and 32, the risk of injury resulting from forceful projection of the center of the airbag toward an occupant's face, known in the art as “bag slapping,” can be lessened.

One preferred embodiment of the present invention has been set forth above, however, it should be appreciated that numerous variations are possible. For example, the number and dimensions of the various folds may be altered. Rather than four tucks along the top and bottom edges 20 and 30, a lesser or greater number of tucks might be made. Moreover, the number of tucks along top edge 20 and bottom edge 30 need not be the same. In some instances, it may be desirable to provide for relatively more or less rapid inflation of regions of the airbag proximate the top and bottom edges. In such applications, the number of tucks can be increased or decreased to increase or decrease, respectively, the resistance to inflation imparted by the tucks. Further, because of increased overlap of the layers of the airbag, and hence increased frictional interaction, it is believed that deeper tucks impart a greater resistance to inflation than relatively shallower tucks, and the depth of tucked regions may be varied accordingly.

The present description is for illustrative purposes only; the description and illustrations herein should not be construed to narrow the scope of the present invention in any way. Thus, those skilled in the art will appreciate that various alterations could be made to the presently disclosed embodiments without departing from the spirit and scope of the present invention. For instance, embodiments are contemplated in which tethers are utilized to assist in optimizing the deployment trajectory of the inflating airbag. The tethers may be attached at varying points in the airbag, and optimal designs depend on the specific vehicle dimensions. Such tethers have also been shown to be useful in volume control of the airbag. When the airbag is maximally expanded under the restraint of the tether(s), excess inflation gas can be discharged through vents in the airbag. Other aspects, features and advantages will be apparent upon an examination of the attached drawing figures and appended claims.

1. A method of folding a substantially rectangular airbag comprising the steps of:
forming a first set of pleats at a top edge of an airbag;
forming a second set of pleats at a bottom edge of an airbag;
folding a first half of the airbag a plurality of times in a direction toward a center of the airbag, thereby forming a first fold body;
folding a second half of the airbag a plurality of times in a direction toward a center of the airbag, thereby forming a second fold body;
wherein upon inflation the airbag initially expands predominantly outwardly, at least partially inflating the first and second fold bodies before the center.

2. The method of claim 1 whereupon inflation of the airbag, the folded first and second halves of the airbag inflate as separate lobes oriented laterally of the center of the airbag.

3. The method of claim 2 wherein the sets of pleats are formed having substantially equal depths.

4. An airbag folded according to the method of claim 1.

5. The airbag of claim 3 wherein the airbag is positioned in an airbag housing and mounted in a vehicle dashboard such that the first and second folded halves are positioned at left and right positions in the vehicle dashboard.

6. An airbag folding method comprising the steps of:
forming a plurality of adjacent tucks having substantially equal depths at a first end of an airbag;
forming a plurality of adjacent tucks having substantially equal depths at a second end of the airbag;
substantially flattening the airbag, thereby forming a plurality of folded edges bounding the tucks;
folding a first half of the airbag a plurality of times along folds oriented substantially orthogonal to the folded edges, thereby forming a first fold body;
folding a second half of the airbag a plurality of times along folds oriented substantially orthogonal to the folded edges, thereby forming a second fold body;
wherein upon supplying an inflation gas to an interior of the airbag, the inflation gas initially predominantly flows into the first and second fold bodies thereby resulting in initial expansion of the airbag in directions lateral of a centerline.

7. The method of claim 7 wherein the steps of forming adjacent tucks at the first end and second end of the airbag comprise forming equal numbers of tucks at the respective ends.

8. The method of claim 7 wherein the steps of forming inward tucks at the first end and the second end of the airbag comprise forming unequal numbers of tucks along the respective edges.

9. The method of claim 8 wherein four tucks are formed at each of the first and second ends of the airbag.

10. The method of claim 10 wherein the tucks at the first end and the tucks at the second end have substantially equal depths.

11. The method of claim 10 wherein the tucks at the first and second ends have depths different from the tucks along the bottom edge.

12. The method of claim 12 wherein the tucks at the first and second ends extend inwardly a distance substantially equal to one half a width of the folded airbag as measured in a direction parallel to the centerline.

14. An airbag folded according to the method of claim 7.

15. An airbag folded according to a method comprising the steps of:
forming four inward tucks at each of a first and second end of an airbag, the tucks having substantially equal depths;
rolling or folding a first lateral half of the airbag a plurality of times, thereby forming a first fold body;
rolling or folding a second lateral half of the airbag a plurality of times, thereby forming a second fold body;
wherein the inward tucks form a plurality of adjacent layers extending along the first and second edges of the airbag that upon supplying an inflation gas to an interior of the airbag resist unfolding, thereby directing the inflation gas initially predominantly into the first and second fold bodies.

16. The airbag of claim 15 wherein an initial directing of inflation gas into the first and second fold bodies initially inflates the fold bodies more rapidly than a center of the airbag, the fold bodies expanding outwardly as two inflating lobes.

17. The airbag of claim 16 wherein the airbag is positioned in an airbag housing and mounted in a vehicle such that upon supplying inflation gas to the airbag, the two inflating lobes are oriented substantially left and right, respectively, of a longitudinal centerline of a vehicle passenger seat.

18. The airbag of claim 15 wherein the first and second fold bodies comprise lower folds hooking outwardly relative to an airbag centerline.

19. The airbag of claim 18 wherein upon supplying an inflation gas to the airbag, the first and second fold bodies are tilted outwardly by an initial expansion of a center of the airbag.
